(19) United States
(12) Patent Application Publication
(10) Pub. No.: US 2013/0141291 A1
(43) Pub. Date: Jun. 6, 2013

(54) ANTENNA ARRANGEMENTS FOR COVERING FREQUENCY BANDS

(71) Applicant: Yuantao Luan, Beijing (CN)

(72) Inventor: Yuantao Luan, Beijing (CN)

(21) Appl. No.: 13/593,748

(22) Filed: Aug. 24, 2012

Related U.S. Application Data
(63) Continuation of application No. PCT/CN2010/070729, filed on Feb. 24, 2010.

(51) Int. Cl. H01Q 5/00

(52) U.S. Cl. CPC H01Q 5/0062
USPC 343/745; 343/700 MS

(57) ABSTRACT

An exemplary embodiment of an antenna arrangement generally includes a board including a ground plane, a radiating element, and a first parasitic element. The radiating element is dimensioned for providing resonance at a first frequency. The radiating element is arranged at a first edge of the board. The first parasitic element is arranged at a second edge of the board opposite the first edge. The first parasitic element is dimensioned for providing resonance at another frequency near the first frequency for providing coverage of a first frequency band. A major extension of the first parasitic element is along the second edge of the board.

### CROSS-REFERENCE TO RELATED APPLICATION

This application is a continuation of PCT International Patent Application No. PCT/CN2010/070729 filed Feb. 24, 2010, published as WO2011/103710. The entire disclosure of the above application is incorporated herein by reference.

### FIELD

The present disclosure relates to antenna arrangements for covering frequency bands using radiating elements and parasitic elements.

### BACKGROUND

This section provides background information related to the present disclosure which is not necessarily prior art.

There is today a demand for mobile phones, and similar portable radio communication devices that communicate over a plurality of frequency bands, such as GSM850, GSM900, GSM1800, GSM1900, and WCDMA2100. It is also desirable to have thin and small sized mobile phones, which puts design restrictions on mobile phone antennas, particularly internal antennas.

One type of radiating antenna element having broad band coverage is the planar inverted F antenna (PIFA) element. This element does in normal cases have good wide-band properties covering a wide low-frequency range. But the bandwidth is dependent on the distance of this element from a ground plane. If the distance is lowered, the bandwidth is also lowered.

Today, portable radio communication devices that employ such radiating elements are getting thinner and thinner. This means that there are severe limitations on the distance to the ground plane. This, in turn, leads to the width of the frequency band covered by a radiating element being diminished, which is severe at low frequencies such as 850 Megahertz (MHz) and 900 MHz. This means that the coverage of low frequencies by such a radiating antenna element is not sufficient.

One way to improve the coverage of a low-frequency band is to add a parasitic element adjacent the radiating element in order to enhance the covered frequency band. But modern antennas are normally adapted to cover more wide frequency bands being of the multiband type. This means that the radiating element will in many cases already be provided with a neighboring parasitic element, which enhances the high band coverage. This may also mean that there is not enough space close to the radiating element for placing a further parasitic element in the vicinity of it.

One way of providing an additional parasitic element in relation to a radiating element in order to enhance the wideband properties is through placing the radiating element at one edge of a printed wire board and a low-band enhancing parasitic element at an opposite edge of the printed wire board and then let this parasitic element stretch towards the radiating element. This type of antenna solution is described in WO 2007/084051. But there is room for improvement in relation to the type of parasitic element solution described in WO 2007/084051.

### SUMMARY

This section provides a general summary of the disclosure, and is not a comprehensive disclosure of its full scope or all of its features.

According to various aspects, exemplary embodiments are disclosed of antenna arrangements or antenna assemblies for covering frequency bands. In an exemplary embodiment, an antenna arrangement or assembly generally includes a board including a ground plane, a radiating element, and a first parasitic element. The radiating element is dimensioned for providing resonance at a first frequency. The radiating element is arranged at a first edge of the board. The first parasitic element is arranged at a second edge of the board opposite the first edge. The first parasitic element is dimensioned for providing resonance at another frequency near the first frequency for providing coverage of a first frequency band. A major extension of the first parasitic element is along the second edge of the board.

In another exemplary embodiment, a portable radio communication device generally includes a board including a ground plane, a radiating element, and a first parasitic element. The radiating element is dimensioned for providing resonance at a first frequency. The radiating element is arranged at a first edge of the board. The first parasitic element is arranged at a second edge of the board opposite the first edge. The first parasitic element is dimensioned for providing resonance at another frequency near the first frequency for providing coverage of a first frequency band. A major extension of the first parasitic element is along the second edge of the board.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a portable electronic device;

FIG. 2 is a sectional view of the portable electronic device shown in FIG. 1;

FIG. 3 is a plan view of an antenna arrangement according to a first exemplary embodiment;

FIG. 4 is a side view of the antenna arrangement shown in FIG. 3;

FIG. 5 is a perspective view of an alternative realization of the first parasitic element on the board;

FIG. 6 is a plan view of an antenna arrangement according to a second exemplary embodiment;

FIG. 7 is a return loss diagram showing frequency in Gigahertz (GHz) versus return loss (RL) in decibels (dB) for an antenna arrangement according to the second embodiment shown in FIG. 6;

FIG. 8 is a circuit diagram of a first variation of the antenna arrangement being connected to a radio circuit;

FIG. 9 is a perspective view of a part of another variation of the antenna arrangement; and

FIG. 10 is a return loss diagram showing frequency in Gigahertz (GHz) versus return loss (RL) in decibels (dB) for an antenna arrangement according to the second embodiment and one of the variations.

### DETAILED DESCRIPTION

Example embodiments will now be described more fully with reference to the accompanying drawings.

Exemplary embodiments are disclosed of antenna arrangements that comprise a radiating element and a parasitic element, which provides good coverage of a desired frequency band despite the fact that the first parasitic element has to be placed far from the radiating element. Exemplary embodiments are also disclosed of portable radio communication devices having such an antenna arrangement, which device provides good wide band coverage of a desirable frequency band when the portable radio communication device has a limited size.

In an exemplary embodiment, an antenna arrangement comprises a radiating element, a board including a ground plane, and a first parasitic element. The radiating element is arranged at a first edge of the board. The first radiating element is configured, e.g., dimensioned, for providing resonance at a first frequency. The first parasitic element is arranged at a second edge of the board opposite the first edge. The first parasitic element is configured, e.g., dimensioned, for providing resonance at another frequency near the first frequency, thereby providing coverage of a first frequency band. The major extension of the first parasitic element is along the second edge of the board. In this exemplary embodiment, it is possible to obtain good coverage of the frequency band despite small distances to ground and despite the fact that the first parasitic element is placed far from the radiating element.

Accordingly, aspects of the present disclosure are generally directed towards antenna arrangements and portable electronic devices including such antenna arrangements, where the antenna arrangement is operable in at least one first frequency band, e.g., a low-frequency band.

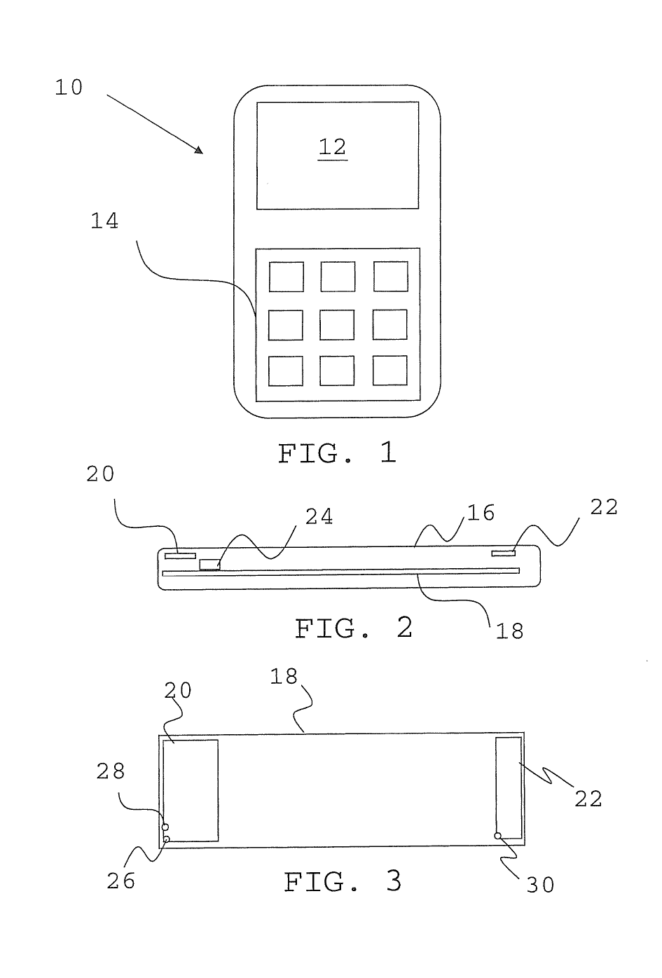

With reference to the figures, FIG. 1 shows a front view of a portable radio communication device 10, such as a mobile phone. The portable radio communication device 10 may be another type of device, such as a laptop computer, a palm top computer, an electronic organizer (e.g., a personal digital assistant (PDA), etc.), among other possible devices.

The portable radio communication device 10 is, as an example, provided with a display 12 and a keypad 14 respectively placed close to an upper end and a lower end of the device 10. These are here provided on the casing of the device 10. But the device may just as well be provided without a display and/or without a keypad. The radio communication device 10 is also provided with at least one antenna. But this example includes all antennas provided inside or in the interior of the device.

FIG. 2 shows a schematic side view of the radio communication device 10, which is a cross section through the casing 16. In order to clarify the description of this exemplary device 10, only elements that are relevant or necessary for understanding are included. Thus, a detailed description of a number of units in the device have here been omitted, like for instance the display 12 and the keypad 14 shown in FIG. 1. The geometrical relationships between the elements and distances shown are furthermore only exemplifying and not necessarily according to scale.

With continued reference to FIG. 2, the radio communication device 10 here includes a board 18, which may be a printed wire board (PWB) or a printed circuit board (PCB). A radiating element 20 is provided above the board 18 at a first edge of the board 18. A first parasitic element 22 is provided above another opposite edge of the board 18. Accordingly, this exemplary embodiment of an antenna arrangement includes the board 18, the radiating element 20, and the first parasitic element 22.

FIG. 2 also illustrates a radio circuit 24, which is here in the form of a cellular transceiver circuit. The radio circuit 24 may, for instance, be used to modulate/demodulate radio frequency signals received and transmitted by the antenna arrangement. The board 18 may be a multi-layer board that also includes a ground plane (not shown).

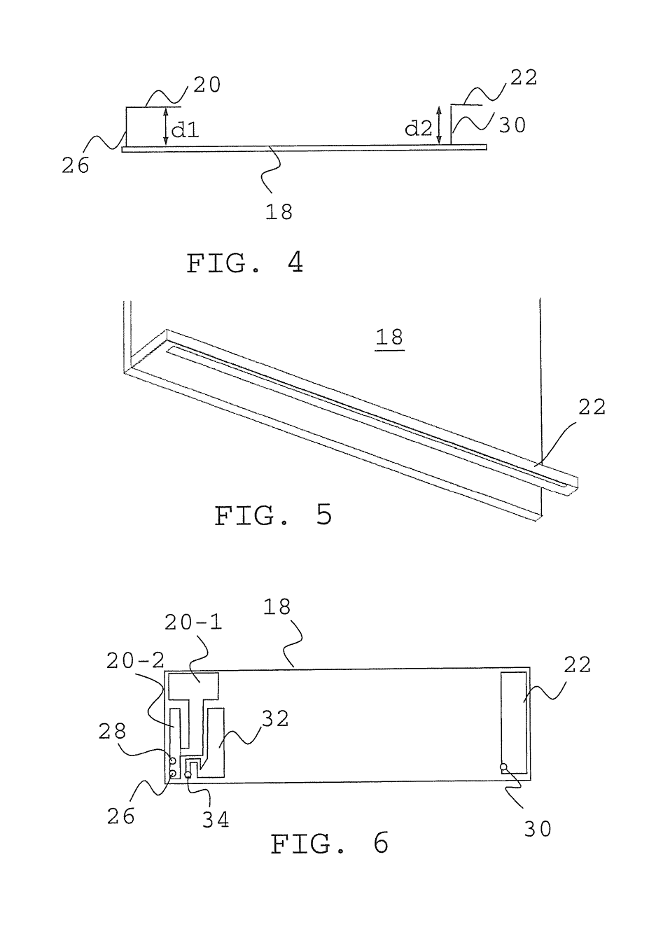

FIG. 3 shows a plan view of the antenna arrangement according to the first exemplary embodiment. FIG. 4 is a side view of the first exemplary embodiment of the antenna arrangement.

The board 18 may extend over an area that is limited by a number of corners. It may typically be rectangular in shape and thus have four corners. The radiating element 20 may be electrically connected to the board 18 at one of these corners. Here, the ground plane of the circuit board 18 may be provided as a layer stretching through the whole of the circuit board. As an alternative, the ground plane may only stretch through a part of the board 18. Normally though, the ground plane may be provided beneath at least the radiating element 20.

As shown in FIG. 2, the radiating element 20 is positioned at a first edge of the board 18. The first parasitic element 22 is positioned at a second edge of the board 18, which second edge is opposite the first edge. The radiating element 20 is connected to the board 18 through a feeding connection 26 leading to the radio circuit. The feeding connection 26 to the radiating element 20 is here provided at a first corner of the board.

In this exemplary embodiment, there is furthermore provided a separate grounding connection 28 for the radiating element 20. Also, this grounding connection 28 is also provided at the first corner. This illustrative placing of the grounding and feeding connections is not required or necessary, as the grounding and feeding connections can be provided essentially anywhere on the radiating element 20. In this first exemplary embodiment, the grounding and feeding connections should preferably be provided fairly close to each other. The first parasitic element 22 is also connected to the board 18 through a grounding connection 30.

With such a placing, the radiating element 20 may stretch out across the board 18 from one long side to an opposite long side. The radiating element 20 may also stretch along a one short side or first edge of the board 18 that may be provided at the upper or lower end of the portable radio communication device.

As mentioned earlier, the feeding and grounding connections 26 and 28 of the radiating element 20 are provided at the first corner of the board 18. This first corner is provided between a first short board side providing the first edge and a first long board side joining the first edge to the second edge. The radiating element 20 here furthermore essentially stretches along this first edge, in parallel with and adjacent the first short side, towards a second long side, and ends at a second corner where the first short side and second long side join each other. The second long side then leads to the second short side at the second edge of the board 18.

The first parasitic element 22 is here provided at the second edge of the board 18 opposite of the first edge. The first parasitic element 22 stretches along and adjacent the second edge or second short side, which second short side joins the first long side to the second long side. The second short side is thus provided opposite the first short side. The first parasitic element 22 thus has an extension that is parallel with the extension of the radiating element 20. It is with advantage straight and here also planar. Also the radiating element 20 may be planar. But other shapes are possible, such as in the form of a wire. Both elements can combine this with, for example, meandering shapes in at least parts of the elements. The major extension of the first parasitic element 22 is along the second edge. This means that it should run longer along this second edge than it runs at right angles to the second edge.

The first parasitic element 22 may thus be elongated, with its direction of elongation provided along the second edge. The first parasitic element 22 may stretch along more than half of the second edge. For the illustrated first embodiment, FIG. 2 shows that the first parasitic element 22 stretches along essentially the whole of the second edge.

The radiating element 20 is configured, e.g., dimensioned, for providing resonance or for resonating at a first frequency or a first low-band frequency, such as a frequency providing coverage of the GSM 850 MHz band. The radiating element 20 is preferably a PIFA element in this exemplary embodiment. But the radiating element 20 is in no way limited to this specific type of radiating element, as the radiating element 20 may be any kind of radiating element, such as an inverted F antenna (IFA), inverted L antenna (ILA), monopole, and folded inverted conformal antenna (FICA) element. In the first embodiment, the radiating element 20 is planar. But the radiating element 20 can have any other suitable shape and thus also be wire-shaped. Furthermore, the radiating element can also be a monopole element such that the grounding connection can be omitted in some embodiments.

The resonance of the radiating element 20 can be obtained through providing an electrical length of the radiating element 20 that essentially is a quarter of a wavelength long for the frequency in question. In this example, the radiating element 20 resonates at a first low band frequency. The first parasitic element 22 is, in turn, configured, e.g., dimensioned, for providing resonance or for resonating at another frequency near the first frequency or a second low-band frequency, that is slightly higher than the first low-band frequency. The second low-band frequency may be a frequency that provides coverage of the GSM 900 MHz band. In this exemplary way, a first frequency band including the GSM 850 and GSM 900 bands is covered.

This resonance of the first parasitic element 22 can also be obtained in the following way. The parasitic element 22 can be seen as having an inductance L depending on the shape of the element, typically on the length, the thickness, and the width. If the element is bent, like if it has a meandering shape, the amount of bending of the element also influences the inductance. It also has a capacitance C determined by the area of the element and the distance to ground. These two properties provide an equivalent resonance circuit, the resonance frequency f_{rc} of which is determined through f_{rc}=(2π*SQRT(LC))⁻¹.

Both the radiating element 20 and the first parasitic element 22 are placed above the board 18. The distance d2 (FIG. 4) between the first parasitic element 22 and the board 18 may be equal to the distance d1 between the radiating element 20 and the board 18. The distance d2 can be higher or smaller than d1. But if d2 is higher than d1, the portable radio communication device may sometimes be thicker than necessary such that d2 is less than d1 in some variations. By way of example, D2 may be 4 millimeters (mm), and d1 may be 5 mm. The performance of the antenna arrangement will be improved if the distances are increased. But larger distances may not be possible in many cases. By way of further example, the width of the first parasitic element 22 may be 9 mm, and the width of the radiating element 20 may be 20 mm.

FIGS. 3 and 4 schematically show the first parasitic element 22 as an element that supports itself. Both the radiating element 20 and the first parasitic element 22 may with advantage be provided through the use of a flex film. The parasitic element 22 could also be attached to a back cover or part of the casing of the portable radio communication device, which would then be connected to the board 18 when the portable radio communication device is assembled. When the first parasitic element 22 is attached to the back cover, then the above mentioned distance d2 will normally be higher than the distance d1.

The antenna arrangement according to the first embodiment is an internal antenna element essentially operating in first low-frequency band. Because the height is so low, the radiating element 20 may not have a good enough wide band coverage. The parasitic element 22 is provided for assisting this coverage. The ordinary placing of such a parasitic element 22 would be such that it is coupled to the radiating element 20, which in many cases is through placing it in the vicinity of the radiating element 20.

As the antenna arrangement is provided within the casing of the portable electronic device, the dimensions of this device puts constraints on the size of the antenna arrangement. The dimensions of the portable radio communication device thus places constraints on the antenna arrangement, which constraints may for instance function to limit the available antenna volume at the first edge of the board. It may therefore not be possible to place the first parasitic element adjacent the radiating element, because of these size restrictions caused by the design of the portable radio communication device.

At the frequencies that are of interest, here from 824 MHz to 960 MHz, one element of the antenna arrangement that has a significant contribution to the antenna arrangement performance is the circuit board 18. The board 18 has a considerable contribution to the radiation of the antenna arrangement. Because the radiating element 20 is provided at the first edge of the board 18, the electrical field strength or the E field jointly caused by these two elements 20, 22 is the strongest at this first edge in the area where the first and second long sides join the first short side. But when this electrical field strength is then further investigated, it can be observed that the electrical field strength gets weaker in the direction away from this first edge towards the second edge. Thereafter, the electrical field again gets stronger as the second edge is approached. At the second edge, the electrical field is then again fairly strong. This fairly strong electrical field is furthermore retained along the second short side of the board along the second edge. In order to obtain an effective parasitic element, the parasitic element 22 is therefore placed at the second edge of the board 18, so that the parasitic element 22 stretches along the second short side. With this placing, a good coupling between the first parasitic element 22 and the circuit board 18 is achieved because of the strong E field, which helps in broadening the frequency range covered by the first radiating element 20.

The first parasitic element 22 does not need to be planar, but can have other shapes. This is evident from FIG. 5 in which a perspective view is shown of a board 18 and an alternatively shaped first parasitic element 22. As can be seen in FIG. 5, the first parasitic element 22 in this example is shaped as a piece of a conductor having a first straight section running at a distance straight above the board 18 along the second edge and then being bent for forming a second straight section leading back towards the point of origin. The second section is here furthermore angled ninety degrees in relation to the first section and placed essentially straight above the second edge.

As mentioned earlier, it is often of interest to provide multiband functionality with antenna arrangements to also cover a high-frequency band, for instance between 1710 and 2170 MHz. A second embodiment is directed towards this situation.

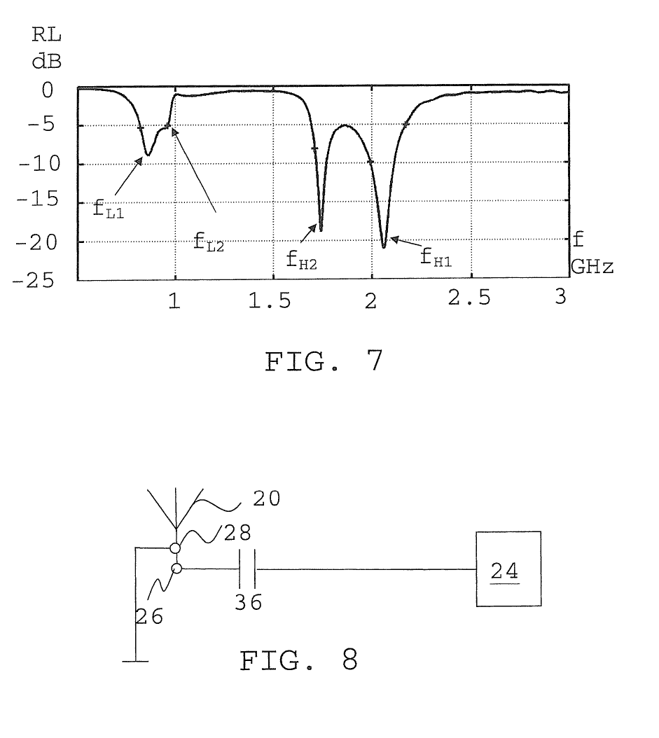

This second embodiment is indicated in FIG. 6, which shows a plan view of the antenna arrangement. In this second embodiment, the antenna arrangement also includes a second parasitic element 32 in addition to the radiating element 20 and the first parasitic element 22. Here, the radiating element 20 has two branches, a first low frequency branch 20-1 and a second high frequency branch 20-2. The first branch 20-1 provides resonance at the first low-band frequency. The second branch 20-2 provides resonance at a first high-band frequency. Each branch is here essentially dimensioned for having a length providing a quarter of a wavelength of the frequency of interest. Also, meandering sections may be used for accomplishing this. Alternative ways of providing resonance are feasible, for instance using only one branch being folded back for forming a gap providing the desired additional resonance.

In order to enhance the coverage in the high-frequency band, the second embodiment includes a second parasitic element 32 placed above the board 18. The second parasitic element 32 has a connection 34 to ground. This connection 34 is provided adjacent the feeding connection 26 of the radiating element 20. The second parasitic element 32 is also provided adjacent the radiating element 20 in order to have a good coupling to the radiating element 20.

The first branch 20-1 of the radiating element 20 is, as before, configured, e.g., dimensioned, for resonating at the first low-band frequency. The second branch 20-2 is configured, e.g., dimensioned, for resonating at a first high-band frequency. The second parasitic element 32 is configured, e.g., dimensioned, for resonating at a second high-band frequency that is here slightly lower than the first high-band frequency. The first parasitic element 22 is, just as in the first embodiment, configured, e.g., dimensioned, for providing resonance at the second low-band frequency. It is in this way possible to provide coverage of a very wide second high-frequency band, for instance between 1710-2170 MHz combined with a coverage of the first low-frequency band.

FIG. 7 is a return loss diagram RL showing the return loss in decibels (dB) in dependence of frequency f in Gigahertz (GHz) for the second embodiment of the antenna arrangement shown in FIG. 6. As can be seen in the diagram of FIG. 7, the first branch 20-1 of the radiating element 20 provides a first low band resonance frequency fᵤ at around 0.840 GHz and −9 dB. The first parasitic element 22 provides a second low band resonance frequency f_{L2} at around 0.960 GHz and −5 dB. The second branch 20-2 of the radiating element 20 furthermore provides a first high band resonance frequency f_{H1} at around 2.07 GHz and −21 dB. The second parasitic element provides a second high band resonance frequency f_{H2} at around 1.74 GHz and −19 dB.

In this way, there is provided an antenna arrangement that is able to cover the whole range of 824-960 MHz as well as the whole range of 1710-2170 MHz even though the antenna volume is limited. This is furthermore done with a limited number of elements, and therefore the production cost is also low.

It is here possible to use a tuning element, for instance in the form of a capacitor, in order to regulate the gain in the two bands. This can be done in order to provide a more even performance in the two frequency bands.

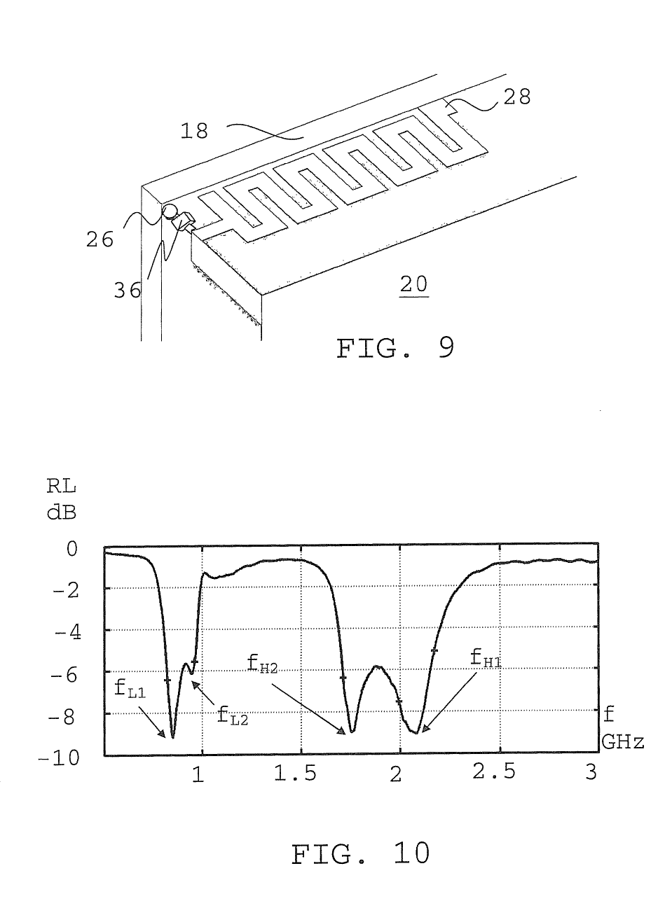

As is shown in the circuit diagram of FIG. 8, a tuning element may be provided in the form of a capacitor 36 between the feeding connection 26 of the radiating element 20 and the radio circuit 24. This indicates that it may be placed on the circuit board. But it may also be provided as a part of the radiating element 20 as is shown in FIG. 9, which shows a perspective view of a part of the radiating element 20 and the board 18. As can be seen in FIG. 9, the tuning element, also here a capacitor 34, is provided in a first conductor leading from the feeding connection 26 to the radiating element 20. Here, there is also a conductor leading from the radiating element 20 to the grounding connection 28 via a second meandering conductor. This meandering shape may be replaced by an inductor component.

As can be seen in both FIGS. 8 and 9, a tuning element in the form of a tuning capacitor 36 may be connected in a series connection between the radiating element 20 and the radio circuit. This capacitor 36 may, in dependence of the requirements of the depth of the resonances in the low-frequency band, have a value in the range of 1-5 picofarads (pF) and may with advantage be 1.5 pF.

The capacitor may be provided as a separate component. But it may also be provided through the use of plates attached to the conductor or a bending of the conductor, where these plates and this bend form a distance between the plates and parts of the conductor that forms the capacitance. It is also possible to use an inductive element instead, which could then also be connected between the radiating element and the feeding connection.

FIG. 10 is a return loss diagram RL showing the return loss in decibels (dB) in dependence of frequency f in Gigahertz (GHz) for an antenna arrangement according to an embodiment of the invention where multiband operation is combined with such a tuning element. As is evident from FIG. 10, the return loss of the resonance frequencies has been evened out as compared with FIG. 7.

There are many variations that may be made in embodiments of the present invention. For example, the ground plane need not cover the whole board, but may only be provided in parts and then parts under the radiating element. The radiating and parasitic elements need not stretch the whole way from the first long side to the second long side. The tuning element may be omitted as may the second parasitic element. The high-band frequency of the radiating element was in the example given above higher than the high band frequency of the second parasitic element. But the opposite situation could also exist. The placing of the radiating element and the first parasitic element is not limited to adjacent short sides. All the sides of the board may for instance have equal length. These elements could also be placed adjacent the long sides of a board. Therefore, the present invention is only to be limited by the following claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. An antenna arrangement comprising:
a board including a ground plane;
a radiating element dimensioned for providing resonance at a first frequency, the radiating element arranged at a first edge of the board; and
a first parasitic element arranged at a second edge of the board opposite the first edge, the first parasitic element dimensioned for providing resonance at another frequency near the first frequency for providing coverage of a first frequency band, wherein a major extension of the first parasitic element is along the second edge of the board.

2. The antenna arrangement of claim 1, wherein the first parasitic element is elongated with its direction of elongation provided along the second edge.

3. The antenna arrangement of claim 1, wherein the first parasitic element stretches along more than half of the second edge.

4. The parasitic element of claim 3, wherein the first parasitic element stretches along essentially the whole of the second edge.

5. The antenna arrangement of claim 1, wherein:
the radiating element is placed at a first distance above the board;
the first parasitic element is placed a second distance above the board; and
the second distance is equal to the first distance.

6. The antenna arrangement of claim 1, wherein:
the radiating element is placed at a first distance above the board;
the first parasitic element is placed a second distance above the board; and
the second distance is less than the first distance.

7. The antenna device of claim 1, wherein:
the radiating element is placed at a first distance above the board;
the first parasitic element is placed a second distance above the board; and
the second distance is higher than the first distance.

8. The antenna arrangement of claim 1, further comprising a tuning element connected to the radiating element.

9. The antenna arrangement of claim 8, wherein the tuning element is placed in a series connection between the radiating element and a radio circuit.

10. The antenna arrangement of claim 9, wherein the tuning element is provided in a conductor leading from a feeding connection of the radiating element to the radiating element.

11. The antenna arrangement of claim 8, wherein the tuning element is a capacitor.

12. The antenna arrangement of claim 1, wherein:
the first frequency is a first low frequency;
the second frequency is a second low frequency;
the frequency band covered by the first and second low frequencies is a low-frequency band; and
the radiating element is further dimensioned for providing resonance at a first high frequency in order to cover a high-frequency band separate from the low-frequency band.

13. The antenna arrangement of claim 12, further comprising a second parasitic element adjacent the radiating element and dimensioned for providing resonance at a second high frequency in order to assist in covering the high-frequency band.

14. The antenna arrangement of claim 13, wherein the high-frequency band covers the frequency range between 1710 and 2170 MHz.

15. The antenna arrangement of claim 1, wherein the radiating element generally extends along the first edge of the board.

16. The antenna arrangement of claim 1, wherein the first frequency band covers the frequency range between 824 MHz and 960 MHz.

17. The antenna arrangement of claim 1, wherein the first parasitic element has an inductance and a capacitance forming a resonance circuit defining the second frequency.

18. A portable radio communication device comprising the antenna arrangement of claim 1.

19. A portable radio communication device comprising:
a board including a ground plane;
a radiating element dimensioned for providing resonance at a first frequency, the radiating element arranged at a first edge of the board; and
a first parasitic element arranged at a second edge of the board opposite the first edge, the first parasitic element dimensioned for providing resonance at another frequency near the first frequency for providing coverage of a first frequency band, wherein a major extension of the first parasitic element is along the second edge of the board.

20. The portable radio communication device of claim 19, wherein:
the radiating element is further dimensioned for providing resonance at a first high frequency in order to cover a high-frequency band separate from the low-frequency band;
a second parasitic element is adjacent the radiating element and dimensioned for providing resonance at a second high frequency in order to assist in covering the high-frequency band;
the high-frequency band covers the frequency range between 1710 and 2170 MHz; and
the first frequency band covers the frequency range between 824 MHz and 960 MHz.
